(19) United States
(12) Patent Application Publication
(10) Pub. No.: US 2025/0209891 A1
(43) Pub. Date: Jun. 26, 2025

(54) SYSTEMS AND METHODS FOR FACILITATING ELECTRONIC TRANSFER OF FUNDS FOR PLACING AND SETTLING WAGERS

(71) Applicant: Global Technology and Sports Limited, Birkikara (MT)

(72) Inventors: David Per Nicklas JACQUET, Skå (SE); Johan Tomas Henrik ERIKSSON, Örebro (SE); Djalal MIRMOHADES, Täby (SE)

(21) Appl. No.: 18/393,421

(22) Filed: Dec. 21, 2023

(51) Int. Cl. G07F 17/32; G06N 5/022; G06N 5/04

(52) U.S. Cl. CPC G07F 17/3288; G06N 5/022; G06N 5/04; G07F 17/323; G07F 17/3244

(57) ABSTRACT

A method includes receiving a first proposition bet represented as a first expression and associated with a sporting event that has yet to commence or that is in progress. Using a statistical model and based on historical data associated with the sporting event, a first mean value is generated. Wager data associated with the first proposition bet is received, and using a backpropagation technique, wager data is aggregated on the parameters of the statistical model. If at least one risk threshold is met, at least one parameter included in the statistical model is modified to result in a modified statistical model. The method also includes receiving a second proposition bet different from the first proposition bet, represented as a second expression, and associated with the sporting event that has yet to commence or that is in progress. Using the modified statistical model, a second mean value is generated.

### FIELD

One or more embodiments described herein relate to systems and computerized methods for facilitating electronic transfer of funds for placing and settling wagers.

### BACKGROUND

Betting operators can offer a predetermined list of bets that are associated with outcomes of an event and that bettors can combine and place wagers on. In some instances, however, bettors can desire to place wagers on additional bets not included in or combinable from the predetermined list of bets. Thus, a need exists for systems and methods for facilitating creation of bets without betting operator intervention, calculation of odds on those bets, placing wagers, adjusting odds based on the wagers and settling wagers.

### SUMMARY

According to an embodiment, a method includes receiving, at a processor, (1) a first expression including at least one first variable associated with an event and not deterministic of a final score for the event, and (2) an event identifier associated with the event. The method also includes predicting, via the processor, based on the first expression and the event identifier, and using a machine learning model trained on historical data associated with the event a first mean value indicating an expected mean of the first expression when the event ends. The method also includes receiving, at the processor, wager data associated with the first expression, and sending, via the processor and based on the wager data, a backpropagation signal to cause a modification to one or more parameters included in the machine learning model to produce a modified machine learning model. The method also includes receiving, at the processor, a second expression including at least one second variable associated with the event, different from the at least one first variable, and not determinative of the final score for the event. The method also includes predicting, via the processor and using the modified machine learning model, a second mean value indicating an expected result of the second expression when the event ends. Additionally, the method includes receiving, at the processor, an indication of a bet associated with one of the first expression or the second expression. The method also includes generating, via the processor and based on live data associated with the event, a variable range for each variable from one of the at least one first variable or the at least one second variable. The method also includes generating, via the processor, an outcome range based on (1) one of the first expression or the second expression and (2) the variable range for each variable from one of the at least one first variable or the at least one second variable. The method also includes sending, via the processor and before the event ends, a signal configured to cause the bet to settle based on the outcome range.

According to an embodiment, a non-transitory processor-readable medium stores code representing instructions to be executed by one or more processors, the instructions including code to cause the one or more processors to receive, via a graphical user interface, at least one bet condition associated with a sporting event and not deterministic of a final score for the sporting event. The code also causes the one or more processors to generate an expression based on the at least one bet condition, send a signal including the expression to a bet facilitation processor, and receive an odds value based on the expression and generated via the bet facilitation processor that used a machine learning model. The code also causes the one or more processors to cause display of the odds value via the graphical user interface, receive, via the graphical user interface and in response to the display of the odds value, a wager value, and receive, while the sporting event is still ongoing, a settlement indication based on at least one outcome occurring in the sporting event. The code also causes the one or more processors to cause, based on the settlement indication and while the sporting event is still ongoing, one of (1) payment of an amount determined based on the odds value and the wager value or (2) display of an indication of a lost bet.

According to an embodiment, a non-transitory processor-readable medium can store code representing instructions to be executed by one or more processors, the instructions including code to cause the one or more processors to receive a first proposition bet represented as a first expression and associated with a sporting event that has yet to commence or that is in progress. The code also causes the one or more processors to generate, using a statistical model and based on historical data associated with the sporting event, a first mean value indicating a first probability that the first proposition bet will be won by a first bettor. The code also causes the one or more processors to receive aggregated wager data associated with the first proposition bet and modify, based on the aggregated wager data and using a backpropagation technique, at least one parameter included in the statistical model to result in a modified statistical model. The code also causes the one or more processors to receive a second proposition bet different from the first proposition bet, represented as a second expression, and associated with the sporting event that has yet to commence or that is in progress. The code also causes the one or more processors to generate, using the modified statistical model, a second mean value indicating a second probability that the second proposition bet will be won by a second bettor.

### BRIEF DESCRIPTION OF THE DRAWINGS

FIG. 1 is a schematic diagram of a bet facilitation system for defining bets, generating odds values, and settling bets, according to an embodiment.

FIG. 2 is a schematic diagram of a compute device included in a bet facilitation system, according to an embodiment.

FIG. 3 is a schematic diagram of software components included in a bet facilitation system, according to an embodiment.

FIG. 4 is a flowchart showing a method to generate odds and cause wagers to settle, according to an embodiment.

FIG. 5 is a flowchart showing a method to receive bet definition information and cause wagers to settle, according to an embodiment.

FIG. 6 is a flowchart showing a method of using a bet facilitation system to modify a machine learning model based on aggregated wager data, according to an embodiment.

### DETAILED DESCRIPTION

Betting odds providers (referred to herein as “providers” and/or “oddsmakers”) can offer a predetermined list of bets (referred to herein as “listed bets”) on an event (e.g., a sporting event (e.g., a match and/or game, used interchangeably herein), an e-sports match, card game, casino game, race, etc.) to their customers. These customers can include, for example, betting operators and/or any entity that brokers, arranges, conducts, etc., a betting activity. For example, a betting operator can offer listed bets received from a provider to bettors, and these bettors can place a wager/bet on these bets. Said differently, a betting odds provider and a customer can form a business-to-business (B2B) relationship, and a customer and a bettor can form a business-to-customer (B2C) relationship. An example of a listed bet can include “home team to win” at odds 2.50, or “more than 10 corner kicks” at odds 2.00. In some instances, the customer can also permit bettors to create a combination of listed bets. An example of a combination bet can include “home team to win and more than 10 corner kicks” at odds 5.00. However, the customer can be limited to offering its bettors the listed bets received from the provider and/or combinations of those listed bets. In some instances, the customer may desire to compete for the bettors by offering unique, custom, and/or bespoke bets to the bettors.

An example of a custom bet can include “home team to score more goals than corner kicks taken by away team.” In some instances, a custom bet can include a proposition bet (e.g., a prop bet, novelty bet, side bet, etc.). A proposition bet can include, for example, a bet associated with an occurrence or non-occurrence during a game (e.g., a soccer match) of an incident that is not deterministic of the game's final outcome and/or final score (e.g., an incident that does not directly affect the game's score and/or an incident that does not include a goal and/or points being scored). For example, such incidents that are not deterministic of a final score can include a team scoring first, both teams scoring, shots on target by a team and/or player, red and/or yellow cards given, etc. In some instances, a custom bet can also include a ticket bet. A ticket bet can include, for example, an offer to “win $10 for every goal scored or corner kick taken, by the home team,” and the customer can set the purchase price for that ticket based on the expected number of goals/corner kicks to be scored/taken by the home team. In some instances, the amount that a bettor can win from a ticket bet can be unbounded. For example, a bettor could win, $0, $10, $20, $30, etc.

In some instances, the customer may not know the accurate probabilities for the occurrences/non-occurrences associated with the proposition bet, custom bet and/or ticket bet. As a result, the customer may not be able to assign accurate odds to the proposition bet and/or custom bet or may not be able to assign an appropriate purchase price for the ticket bet, which can create a risk of loss for the customer and/or cause the customer to be uncompetitive compared to other betting operators. In some instances, the customer may ask the provider to add an additional/new bet to the listed bets. To fulfill this request, however, a provider might have to create a new prediction model, create new settling procedures for settling wagers placed on the new bet, change and/or create a new communication protocol (e.g., an API) to send and/or receive information associated with the new bet, modify terms and/or conditions of a contract between the provider and the customer, communicate know-how and/or provide training to improve the customer's understanding of how to operate the bet, etc.

At least one embodiment described herein relates to a bet facilitation system that can automatically (e.g., without human intervention from a provider and/or oddsmaker) generate odds values for customers (e.g., betting operators) and/or bettors based on, for example, custom bets defined by the customers and/or bettors. For example, the bet facilitation system can include an interface through which a customer and/or bettor can define a custom bet (e.g., by defining an expression associated with a domain-specific programming language). In some instances, the custom bet can be predicated on an occurrence associated with an event (e.g., a sporting event). Having generated an odds value for the defined custom bet, the bet facilitation system can also settle wagers placed by bettors based on the progression of the event (e.g., incidents that occur during the event, as conveyed through live data) associated with the custom bet. The bet facilitation system can also settle wagers before the event ends. Furthermore, the bet facilitation system can modify odds values for future bets based on aggregated wager data associated with previous bets to reduce risk of loss for customers.

### Expression and Variable Definition

To define an outcome (e.g., an occurrence or non-occurrence associated with a sporting event and that determines whether a bet is won or lost), a customer can provide as input to the bet facilitation system an expression(s). The expression can be defined by the customer and/or generated based on inputs received from a bettor. For example, the bet facilitation system can include an interface (e.g., a graphical user interface (GUI)) that a customer can customize and present to bettors who wish to define an outcome and/or construct a bet. Based on inputs received from a bettor via the interface, the bet facilitation system can be configured to automatically generate the expression.

An expression can include one or more variables and zero or more mathematical operators (e.g., unary, binary, etc. relations or functions). A variable can include, for example, a name, an associated data type and state describing an event or an incident that can occur within an event (e.g., a sporting event). For the purpose of illustration, a variable can include, for example, a name “nr_of_goals_home_team” associated with an integer datatype and representing the number of goals scored by the home team of a match/game (e.g., a soccer game, hockey game, etc.) at given point in time (e.g., after a given period of time has elapsed since the start of the match). In this case, the example variable can start with a value of 0 and can increase by 1 after each goal scored by the home team. For the purpose of illustration, an expression can include, for example, the expression “nr_of_goals_home_team+nr_of_corners_home_team,” where “nr_of_corners_home_team” is a variable and/or a string associated with an integer datatype and representing a number of corner kicks taken by the home team. This expression includes, for the purpose of illustration, an addition operator. Therefore, this expression can represent the sum of the number of goals scored by the home team and the number of corner kicks taken by that home team. In some instances, this expression can be associated with, for example, a ticket bet, where the result (e.g., evaluation) of the expression can increment each time a goal is scored by the home team and each time a corner kick is taken by the home team. As a result of the expression incrementing, the bet facilitation system can be configured to distribute an incremental (e.g., predefined) payout to a bettor(s).

In some instances, an expression can include a Boolean expression. A Boolean expression can evaluate to one of two values. For example, a Boolean expression can evaluate to 0 (e.g., a value indicating false) or 1 (e.g., a value indicating true). For the purpose of illustration, a Boolean expression can include, for example, the Boolean expression “nr_of_goals_home_team>nr_of_goals_away_team,” where “nr_of_goals_away_team” is a variable and/or string associated with an integer and representing a number of goals scored by the away team of the match. Thus, this Boolean expression can stipulate an outcome where the number of goals scored by the home team of a match is greater than the number of goals scored by the away team. A Boolean expression can be associated with, for example, a money line bet, a point spread bet, an over/under (e.g., totals) bet, a futures bet, a proposition bet, etc. In some instances, multiple Boolean expressions can be combined within a single bet. This type of bet can include, for example, a parlay bet, a teaser bet, etc. For example, for a parlay bet associated with multiple expressions, the parlay bet can result in a payout if the evaluation and/or result of each expression evaluates to true (e.g., based on occurrences or non-occurrences within a single match or across multiple matches).

In some implementations, a Boolean language can be represented by a domain-specific programming language (e.g., a domain-specific language and/or DSL). A domain-specific programming language can include, for example, a programming language configured to be used in a narrowed (e.g., specific) subset of at least one application. In some instances, a domain-specific programming language can be distinguished from, for example, a general-purpose programming language that can apply broadly across a plurality of domains/applications. A domain-specific language can include, for example, custom (e.g., unique) syntax to achieve a goal and/or implementation that can be used to solve a problem associated with the domain. For example, a customer and/or the bet facilitation system can define an expression using a domain-specific programming language associated with syntax configured to define, for example, occurrences (e.g., goals, corner kicks, penalties, final scores, etc.) and/or teams/players (e.g., home team, away team, quarterback, etc.) associated with a sporting event

In some implementations, the bet facilitation system can be configured to further receive from a customer and/or bettor an event identifier associated with the event. In some implementations, a bettor can cause the event identifier to be sent to the bet facilitation system based on a selection that the bettor can make via the user interface. In some instances, the bet facilitation system can receive multiple event identifiers associated with a single bet (e.g., a parlay bet). The event identifier can include, for example, an indication of two teams and/or entities (e.g., competitors, players, etc.) involved in the event, a time associated with the event (e.g., a date on which the event is held), etc. For the purpose of illustration, an event identifier can include data the indicates “Vancouver Canucks vs. Edmonton Oilers on Oct. 7,” “Manchester United vs. Tottenham Hotspur today,” “Preakness Stakes 2023,” and/or the like.

### Mean Evaluator

Having received and/or generated an expression(s) and/or an event identifier(s), the bet facilitation system can be configured to evaluate and/or estimate (e.g., predict) a mean value(s) associated with that expression(s). In some implementations, the bet facilitation system can include an application and/or software component (e.g., a mean evaluator, described herein) configured to predict the mean value(s). The bet facilitation system can estimate the mean value(s) while the event(s) (e.g., a sporting event(s)) associated with the expression(s) has yet to commence, is in progress, and/or has yet to end (e.g., before a final score/outcome for the event has been determined). The mean value can represent, for example, an expected result/evaluation of an expression. For the purpose of illustration, the bet facilitation system can receive the example expression “nr_of_goals_home_team+nr_of_corners_home_team” and the event identifier “Team A vs Team B at date C.” In response, the bet facilitation system can automatically generate a predicted (e.g., expected, mean, average, and/or the like) number (e.g., 12.4 and/or the like) of goals and corners to be made by the home team during that given match.

In another example, for the purpose of illustration, the bet facilitation system can receive the example Boolean expression “nr_of_goals_home_team>nr_of_goals_away_team” and the event identifier “Team A vs Team B at date C.” In response, the bet facilitation system can automatically generate a mean value of the outcome of the Boolean expression. The outcome of a Boolean expression can be either 1 (representing true) or 0 (representing false), depending on occurrences that transpire during the event/match. Therefore, the mean value of a Boolean expression can be interpreted as the probability of that Boolean expression having a true outcome when the match is over. For example, in response to receiving the example Boolean expression above, the bet facilitation system can generate a mean value of 0.62, indicating that the probability of the number of goals scored by home team being larger than the number of goals scored by the away team when the event ends is 62%.

In some instances, an expression can include at least two variables that are each not determinative of a final score for an event. For example, the expression “nr_of_high_sticking_penalties+nr_of_icing_calls_against_home_team” can include two variables (e.g., a first variable associated with the total number of high sticking penalties committed by both teams in a hockey game and a second variable associated with the number of icing calls against the home team), where neither variable is determinative of the final score (e.g., the number of goals scored by one team and/or the number of goals scored by the other team) of the hockey game.

In some implementations, the bet facilitation system can be configured to generate a parse tree (e.g., a binary expression tree, a Boolean expression tree, etc.) for each expression received, and the bet facilitation system can be configured to use the parse tree to generate the mean value. A parse tree can include a tree data structure (e.g., a binary tree) that represents an algebraic or Boolean expression. In some implementations, a parse tree can include a node for each variable and operator (e.g., unary and/or binary operator) included in the expression. A parse tree can be configured to represent algebraic operators (e.g., operators associated with multiplication, division, addition, subtraction, exponentiation, negation, etc.) and/or Boolean operators (e.g., operators associated with AND, OR, NOT, XOR, etc.). As a result of each node in a parse tree having zero children, one child, two children, etc., the simplified structure of a parse tree can improve processing efficiency of the expression. For example, by generating a parse tree based on an expression, the bet facilitation system can parse the parse tree to determine a relationship(s) between variables as defined by an operator(s).

The facilitation system can use a machine learning model(s) (e.g., a machine learning algorithm) and/or a statistical model(s) to generate and/or predict the mean value, expected result, probability, etc., associated with an expression. These models and/or methods can be trained and/or developed based on, for example, historical data. Historical data can include, for example, occurrence and/or result data associated with previous events associated with and/or having at least one similarity to the event indicated by the received event identifier. For example, the at least one similarity can include a same team (e.g., Liverpool F.C.) playing in both the event indicated by the event identifier (e.g., the event of interest) and the previous events, a matchup between teams having similar records/rankings, a matchup between teams having similar goals-for and/or goals against differentials between the two teams, etc. The occurrence and/or result data included in the historical data can include, for example, an indication of a final score, goals scored, penalties/cards/flags issued, player performance metrics (e.g., individual goals scored and/or shots taken), weather data, temporal data (e.g., an indication of an early season game or a playoff game), etc.

In some instances, existing historical data associated with past events that are sufficiently similar to the event of interest can include a sample size that is too small to generate an accurate mean value for the expression associated with the event of interest. For example, because each sport event/match can be unique due to different teams playing, different tactics being employed, injuries to players, weather, spectator engagement, homefield advantage, etc., there may be few previous events that are similar to the event of interest and from which historical data can be used. In some implementations, the bet facilitation system can be configured to augment and/or supplement the historical data by generating (e.g., simulating) synthetic events (e.g., fictitious events and/or simulated events) and/or synthetic data based on the historical data. The synthetic data can be generated using, for example, a regression model, neural networks (e.g., convolutional neural networks, recurrent neural networks, Long Short-Term Memory (LSTM) neural networks, generative adversarial neural networks (GANNs), etc.), ensemble methods, Monte Carlo simulations, nearest neighbor methods, principal component analysis, etc.

In some instances, the bet facilitation can receive numerous requests for odds (e.g., thousands of requests per second involving different expressions and/or variables) from multiple customers, bettors, etc., prior to, for example, a popular sporting event. In some instances, some of these requests can be associated with a variable (e.g., number of bicycle kicks, number of times a professional basketball player scores 60 or more points in a single season, a pitcher throws a perfect game, etc.) for which there is little historical data. To generate synthetic data fast enough to meet this demand, the bet facilitation system can be configured to use parallel computing to perform simulation of synthetic events because each simulation can be performed independently from other simulations. In some implementations, the bet facilitation system can be configured to cache simulation results (e.g., synthetic data) generated for an earlier request, those results to be used to predict a mean value for a future request associated with, for example, at least one variable that is similar to at least one variable associated with the earlier request. The bet facilitation system can cache the simulation results in a memory (e.g., a server, local memory, remote store, etc.) to improve the performance (e.g., time-to-completion) of determining a mean value to fulfill the future request. In some implementations, the bet facilitation system can be configured to cache responses generated for earlier requests in a memory (e.g., a server, local memory, remote store, etc.) to improve the performance (e.g., time-to-completion) to fulfill future requests. For example, the mean evaluator can cache a mean value for a previous request to be used for a future request if certain conditions are met, such as less than a predefined time having passed, an underlying condition(s) in the sport remaining unchanged, or that the two expressions are equivalent. For example, the boolean expression “X<Y” can be equivalent to the Boolean expression “X−Y<0”.

Based on the historical data and/or synthetic data, the bet facilitation system can be configured to generate a mean value using a machine learning model (e.g., a neural network, regression model, and/or the like). For example, the historical data and/or synthetic data can be used to parameterize at least one parameter and/or weight included in the machine learning model. In addition to a mean value, the bet facilitation system can also generate an associated confidence value, confidence interval, prediction value, prediction interval, and/or the like. For example, the confidence value and/or interval can indicate a spread of possible values rather than a single mean value and/or a likelihood that an observed outcome will fall within a range/spread of values. This spread can be the result of, for example, variance (e.g., variability), uncertainty, and/or sampling error associated with the model. For example, for a generated mean value of 12.5 (e.g., representing the expected number of flags drawn by two gridiron football teams playing in a match), the bet facilitation system can also generate a 95% confidence value of +5 flags.

### Odds Calculator

Having generated a mean value(s) associated with an expression(s), the bet facilitation system can be further configured to generate an odds value, based on the generated mean value. For example, for the expression “nr_of_goals_home_team+nr_of_corners_home_team,” which can be associated with a ticket bet that offers an incremental payout of $10 for each goal or corner attributed to the home team, the bet facilitation system can be configured to determine a mean value (e.g., an expected number of goals and corners by the home team) of 12.4. Based on the incremental payout and the mean value, the bet facilitation system can be configured to determine an expected total payout value of $124 for that ticket. Based on the expected total payout, the customer can provide as input a desired net profit margin and/or payout rate (described herein), that can be used to modify the expected total payout amount to result in a ticket price that can net a customer profit. For example, in the example above, the customer can define a net profit margin of $6, which can be added to the expected total payout value of $124 to result in a ticket price of $130. This ticket price can then be paid by the bettor to the customer to initiate the ticket bet. The ticket price is an example of an odds value, given that the ticket price is representative of the likelihood of an outcome of the expression.

To illustrate another example, for the Boolean expression “nr_of_corners_home_team>nr_of_corners_away_team” associated with a bet (e.g., a proposition bet), the bet facilitation system can be configured to determine a mean value (i.e., a probability) of 1/3 (i.e., approximately 33%) that the expression will evaluate to true (i.e., a value of 1) at the conclusion of the event. The customer can provide as input to the bet facilitation system a payout rate (e.g., bet offer payback ratio) that can indicate, for example, a desired payout to received wager ratio. In the example above, the customer can define a payout rate of 90%. Based on the mean value of 1/3 and the payout rate of 90%, the bet system can be configured to determine an odds value of 2.7, and the bet facilitation system can be configured to display this odds value to solicit a wager from the bettor for the bet. In some implementations, the bet facilitation system can include an application and/or software component (e.g., the odds calculator, described herein) configured to generate odds values and/or ticket prices. The application and/or software component can further be configured to use a custom formula to generate odds from the estimated probability of the bet, the estimated uncertainty of that probability, parameters (e.g., payout rate) and probability of other complementary events (for example, for a bet on “home team to win”, the complementary events may be “away team to win” and “draw”).

### Range Evaluator

Having generated a mean value(s) associated with an expression(s), the bet facilitation system can be further configured to generate a range (e.g., a variable range) of possible values for each variable included in the expression(s). In some implementations, the bet facilitation system can update this range contemporaneously as to one or more occurrences within an event. For example, the bet facilitation system can be configured to receive live data (e.g., real time data, near-real time data, contemporaneous data, and/or the like) associated with a sporting event that has commenced and has yet to end. In some implementations, the bet facilitation system can include an application and/or software component (e.g., a range evaluator, as described herein) configured to generate the range for each variable based on the live data. In some implementations, the bet facilitation system can generate a variable range in response to a query from a customer and/or bettor. For the purpose of illustration, the bet facilitation system can determine a range for the variable “nr_of_goals_home_team” in an event having the event identifier “Team A vs Team B at date C.” If, for example, the event has not yet started, then the bet facilitation system can generate a variable range [0, infinity) because any non-negative integer is a possible value for this variable. If, for example, the event is ongoing and two goals have been scored by the home team (as indicated in the live data received by the bet facilitation system), the bet facilitation system can generate a variable range [2, infinity). If, for example, the event has ended and three goals have been scored by the home team, the bet facilitation system can generate a variable range [3].

### Settlement Calculator

In some embodiments, the bet facilitation system can be configured to generate an outcome range (e.g., a future outcome range) associated with an evaluation (e.g., result) of an expression based on the variable range for each variable included in the expression. The bet facilitation system can generate and/or update an outcome range contemporaneously as to one or more occurrences within an event. For example, the bet facilitation system can be configured to receive (e.g., via a data stream) live data (e.g., from a sports data provider, broadcaster, etc.), and the bet facilitation system 100 can generate and/or update the variable ranges based on the live data. In some implementations, the bet facilitation system can include an application and/or software component (e.g., a settlement calculator, as described herein) configured to generate the range for each variable based on the live data. For the purpose of illustration, the bet facilitation system can receive, while a match is ongoing, the expression “nr_of_goals_home_team+nr_of_corners_home_team,” a first variable range of [2, infinity) for the first variable “nr_of_goals_home_team,” and a second variable range of [5, infinity) for the variable nr_of_corners_home_team. As a result of the first variable range indicating a possible value at the end of the event being at least 2 and the second variable range indicating a possible value being at least 5, the sum (as determined by the operator included in the expression) can be at least 7, so the bet facilitation system can return an outcome range for the expression of [7, infinity).

To illustrate another example, the bet facilitation system can receive the Boolean expression “nr_of_goals_home_team>1 OR nr_of_corners_home_team>10” with variable ranges [2, infinity) and [5, infinity) for the variables “nr_of_goals_home_team” and “nr_of_corners_home_team,” respectively. In this example, the match can be ongoing (e.g., yet to end), but because the home team has already scored two goals (i.e., more than one goal), the bet facilitation system can determine that for all possible future values of each of two variables included in the expression, the expression will evaluate to 1 (i.e., true). As a result, the bet facilitation system can return an outcome range of [1] for the Boolean expression based on the progression of the event. As a result, the bet facilitation system can indicate (e.g., by sending a settlement indication) to the customer and/or bettor that the bet associated with the expression is to be settled, even though the match is still ongoing/has yet to end. A bet can be settled, for example, by a customer issuing of payment to the bettor for a bet that the bettor has won or by informing the bettor of a lost bet by, for example, displaying (e.g., via the GUI) an indication that the bettor has lost the bet. If the bettor has won the bet based on the selected and/or defined expression, the payment amount is issued to the bettor based on the odds value and/or ticket price generated by the bet facilitation system.

### Risk Aggregator

In some instances, a customer (e.g., a betting operator) can organize a marketplace of bets, where odds values for the bets can fluctuate over time rather than remain fixed. Similar to some stock traders, some bettors can form a notion and/or perception of what a fair odds value might be for an occurrence and/or outcome associated with an event based on, for example, news, rumors, emotions, etc. In some instances, if bettors intuit that an odds value for a particular bet is profitable for the bettor (e.g., the odds value is too high (indicating a high payout relative to the underlying probability) for an occurrence and/or outcome that is likely), the customer can be at risk of losing money.

In some embodiments, the bet facilitation system can be configured to determine aggregated risk across multiple bets based on odds values generated by the bet facilitation system. In some implementations, the bet facilitation system can determine aggregated risk based on wager data (e.g., average wager value, number of wagers, etc.) associated with an expression and/or variable and aggregated over multiple bets and/or bettors. For example, a wager placed by a bettor can be interpreted as that bettor having an opinion that the odds value for the bet being wagered on is too high (e.g., the bet is more likely to payout than what is indicated by the bet's odds value). Thus, the wager data (e.g., wager amount in fiat currency, tokens, etc.) associated with the wager can be used as a signal to perform a backpropagation technique. Specifically, the signal (e.g., a backpropagation signal) can be propagated backwards (e.g., back fed) through the machine learning model and/or statistical model used to generate the odds value for the bet being wagered on. As a result of backpropagating the signal (which can represent and/or be based on the wager data) through the model, the bet facilitation system can be configured to adjust and/or modify one or more weights and/or parameters included in the model that generated the mean value. Using a technique such as a gradient descent technique, the one or more weights and/or parameters can be adjusted based on, for example, a gradient associated with the model (e.g., the change in generated mean values as a result of changes to the model parameters).

For the purpose of illustration, if received aggregated wager data indicates that a bet, expression, and/or variable is associated with a large number of wagers, high wager amounts (e.g., a high number of wagers being over a threshold monetary value), and/or a high average wager amount, etc., the bet facilitation system can determine that the odds value(s) associated with associated with the bet, expression, and/or variable is too high and/or risks a large and/or unprofitable aggregated payout. To compensate for the high odds value(s), the bet facilitation system can generate a backpropagation signal based on the aggregated wager data and use the backpropagation signal to cause a modification to one or more parameters included in the machine learning model and/or statistical model that generates an underlying mean value(s) to determine the odds value(s) for the current bet. A modified machine learning model and/or a modified statistical model can result from the modification to the one or more parameters. The modified machine learning model/modified statistical model can be configured to generate (e.g., predict) a revised odds value(s) that, in the above example, can be lower than the odds value(s) that the bet facilitation system determined was too high and/or presented too much risk. The revised odds value can be associated with a future bet, that future bet being associated with, for example and as compared to the current bet above, a similar variable, the same event, a similar event, a similar event type, etc. The bet facilitation system can cause display of a revised odds value to subsequent bettors who are considering wagering on a similar bet, expression, and/or variable. In some implementations, the modified machine learning model/modified statistical model can generate a revised odds value for a bet that is not equivalent to the bet for which wager data was used to cause the modification to the model. For example, the modified model can be used to generate revised odds values for subsequent bets having similar characteristics (e.g., as compared to the original bet, subsequent bets associated with: a similar variable(s), a same event, a different event having the same event type (e.g., a different event of the same sport and/or league), a different event involving the same team(s) and/or different team(s), etc.).

With some known systems, some providers that offer listed bets are unable to aggregate risk on combinations of listed bets due to a large number of possible combinations. As a result, some bettors can exploit/abuse this inability by, for example, deliberately combining “a bet of interest” (e.g., a bet with a favorable odds value that is profitable for the bettor) with at least another bet of interest or at least a “non-interesting bet” (e.g., a bet associated with a low odds value having a high probability of payout or a bet that has high probability of payout conditional on winning the bet(s) of interest, for example by combining the bet of interest “home team to win” with the non-interesting bet “more than 2.5 corners”). By combining bets like above, a bettor can avoid detection and/or proper action from the betting operator if the betting operator fails to identify the connection between the placed combination bet and the “bet of interest” and does not aggregate risk properly. Thus, a need exists for systems and methods that can implement countermeasures to inaccurate odds values that can cause a loss of profitability for a customer.

In some embodiments, the bet facilitation system can be configured to determine aggregated risk across parameters based on back-propagated signals generated by the bet facilitation system. The back-propagation algorithm can map bets placed by bettors and/or signals generated from the bets and/or bettors on an unlimited or very large set of expressions (e.g., Boolean expressions) to a finite space of parameters and/or weights (e.g., a finite set of parameters or a finite-dimensional vector space of parameters). Risk can then be aggregated on the parameters and/or weights or as vectors in a vector space of parameters and/or weights or in a related vector space. A decision on whether to change one or more parameters can then be made based on the aggregated risk (which may depend on the amount wagered, odds, probability, payback, uncertainty, etc.) and risk threshold(s) (specific to the system implementation, sport, tier, match, country, customers risk preferences etc.).

For the purpose of illustration, multiple bettors can aim to place bets on the common bet of interest “home team to win” for a soccer match. The bettors can choose to combine the bet with other non-interesting bets that are guaranteed to happen or very likely to happen. Alternatively or in addition, the betters can choose bets that are conditionally guaranteed to happen or conditionally very likely to happen, conditional on the bet of interest to be won. In doing so, the bettors can believe that combination bets are more difficult for the provider to detect risk accumulation and/or take action that is unfavorable to the bettor. For example, the first bettor can place $60 on the bet “home team to win AND more than 2.5 corners”. The second bettor can place $60 on “home team to win and more than 0.5 goals”. The non-interesting bet “more than 2.5 corners” can be very likely to happen and the non-interesting bet “more than 0.5 goals” can be guaranteed to happen conditional on the home team winning. The bet facilitation system can have a parameter, weight or vector, that controls the estimated relative strength of the home team against the away team and both these bets can be mapped to that parameter (or to a vector close to that vector). The bet facilitation system can then aggregate these two bets and can (1) determine an adjustment for the parameter, weight or vector, (2) reduce the allowed maximum stake, (3) increase the uncertainty, (4) reduce the payback, and/or (5) take another measure or measures to respond to the accumulated risk.

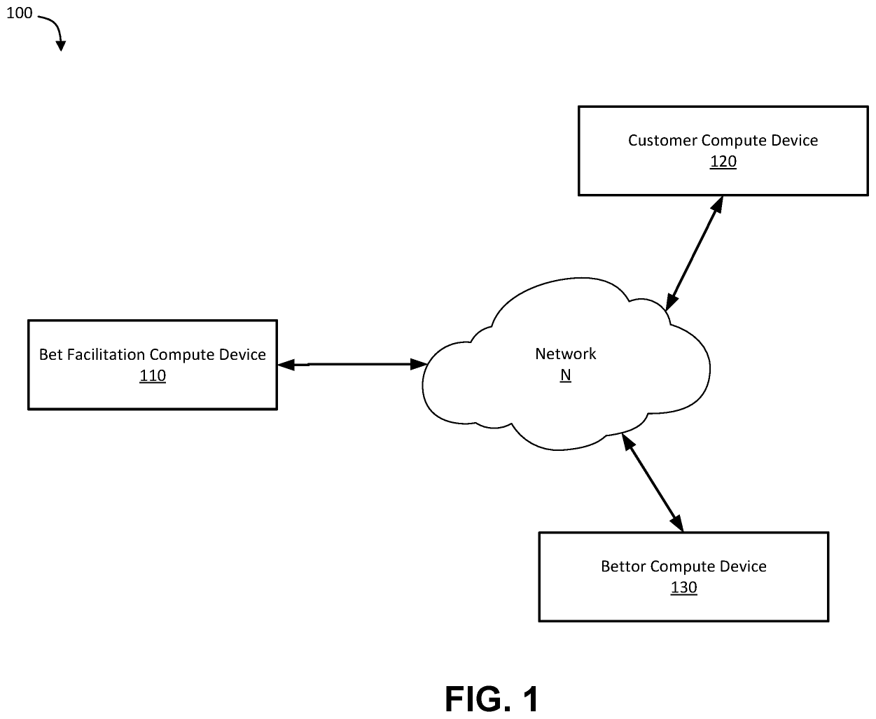

FIG. 1 is a schematic diagram of a bet facilitation system 100 for defining bets, generating odds values, and settling bets, according to an embodiment. The bet facilitation system 100 includes a bet facilitation compute device 110, a customer compute device 120, a bettor compute device 130, and a network N. The bet facilitation system 100 can include alternative configurations, and various steps and/or functions of the processes described below can be shared among the various devices of the bet facilitation system 100 or can be assigned to specific devices (e.g., the bet facilitation compute device 110, the customer compute device 120, the bettor compute device 130, and/or the like). Although not shown in FIG. 1, in some embodiments, the bet facilitation system 100 can include a plurality of customer compute devices 120 and/or bettor compute devices 130 associated with, for example, a plurality of betting operators and/or bettors. Alternatively or in addition, in some embodiments, a bet facilitation system 100 can include a plurality of bet facilitation compute devices 110, where, in some implementations, functions of a facilitation compute device 110 can be distributed among the plurality of bet facilitation compute devices 110 or, in some implementations, each facilitation compute device 110 can operate independently.

Each of the compute devices included in the bet facilitation system 100 (e.g., the bet facilitation compute device 110, the customer compute device 120, the bettor compute device 130, and/or the like) can include any suitable hardware-based computing devices and/or multimedia devices, such as, for example, a server, a desktop compute device, a smartphone, a tablet, a wearable device, a laptop and/or the like. In some implementations, each of the compute devices included in the bet facilitation system 100 can be implemented at a data center or other control facility configured to run or execute a distributed computing system and can communicate with other compute devices. As described herein, the customer compute device 120 can be associated with, for example, a customer (e.g., a betting operator) and the bettor compute device 130 can be associated with a bettor. In some implementations, the customer compute device 120 can include and/or implement a display and/or a graphical user interface (GUI), that can, for example, receive user inputs (e.g., at least one condition used to define an expression, an event identifier, etc.), display odds values, display settlement information (e.g., a payout amount, an indication that a bet has been won or lost, etc.). In some implementations, the GUI can receive an indication of a wager amount from a bettor in response to odds values being displayed to the bettor for a bet that was generated based on the user inputs.

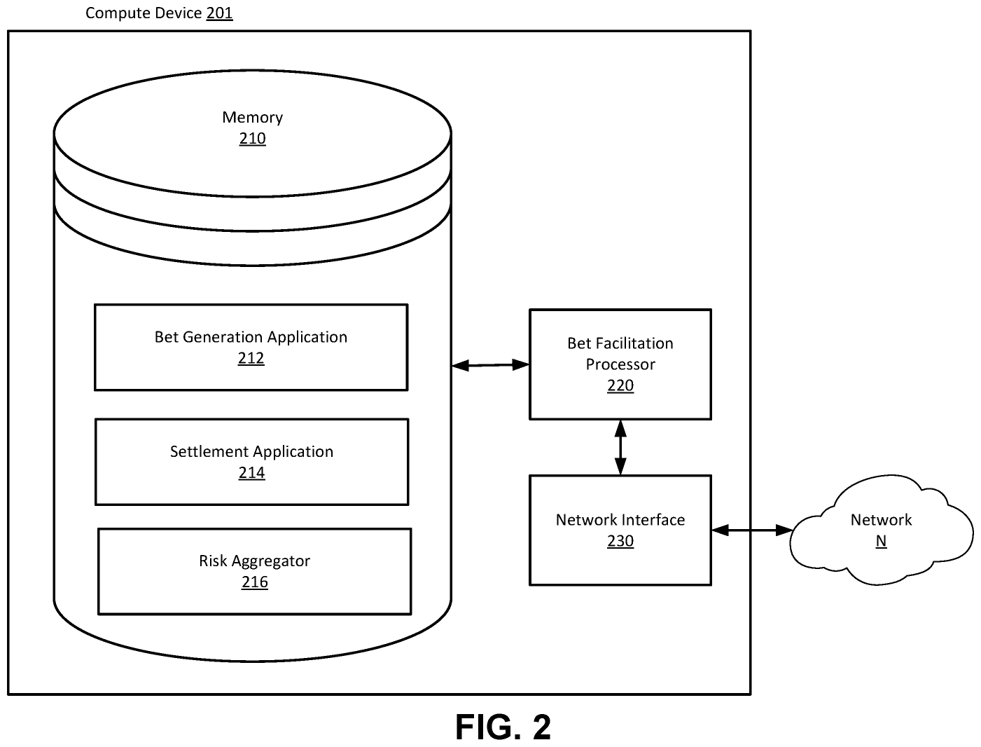

The bet facilitation compute device 110 can be configured to execute, at a processor, a bet generation application (e.g., the bet generation application 212 of FIG. 2), a settlement application (e.g., the settlement application 214 of FIG. 2), and/or a risk aggregator (e.g., the risk aggregator 216 of FIG. 2). The bet generation application can generate odds values based on inputs (e.g., at least one condition, an expression, at least one variable, an event identifier, etc.) received from the customer compute device 120 and/or the bettor compute device 130. The settlement application can, in response to receiving wager data from the customer compute device 120, cause a bet associated with the inputs received at the bet generation application to settle (e.g., by indicating a payout amount and/or an indication of whether a bet has been won or lost) while an event associated with the bet is still in progress. The risk aggregator can accumulate wager data for instances of a bet and/or multiple bets and adjust model parameters to produce a modified model that generates revised odds for future bets.

A device included in the bet facilitation system 100 can be networked to at least one other device included in the bet facilitation system 100, via the network N, using wired connections and/or wireless connections. In some examples, the bet facilitation system 100 described herein can be implemented in a betting platform that is associated with the network N. The network N can include various configurations and protocols, including short range communication protocols such as, for example, Bluetooth®, Bluetooth® LE, the Internet, World Wide Web, intranets, virtual private networks, wide area networks, local networks, private networks using communication protocols proprietary to one or more companies, Ethernet, Wi-Fi® and HTTP, and/or various combinations of the foregoing. Communication using such configurations and protocols can be facilitated by any device capable of transmitting data to and from other compute devices, such as a modem(s) and/or a wireless interface(s).

FIG. 2 is a schematic diagram of a compute device 201 of a system, according to an embodiment. The compute device 201 can be structurally and/or functionally similar to, for example, the bet facilitation compute device 110 of the bet facilitation system 100 shown in FIG. 1. Compute device 201 can be a hardware-based computing device, a multimedia device, or a cloud-based device such as, for example, a computer device, a server, a desktop compute device, a laptop, a smartphone, a tablet, a wearable device, a remote computing infrastructure, and/or the like. Compute device 201 includes a memory 210, a processor 220, and a network interface 230.

The processor 220 can be, for example, a hardware based integrated circuit (IC), or any other suitable processing device configured to run and/or execute a set of instructions or code (e.g., stored in memory 210). For example, the processor 220 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC), a remote cluster of one or more processors associated with a cloud-based computing infrastructure and/or the like. The processor 220 is operatively coupled to the memory 210 (described herein). In some embodiments, for example, the processor 220 can be coupled to the memory 210 through a system bus (for example, address bus, data bus and/or control bus).

The memory 210 can be, for example, a random-access memory (RAM), a memory buffer, a hard drive, a read-only memory (ROM), an erasable programmable read-only memory (EPROM), and/or the like. The memory 210 can store, for example, one or more software modules and/or code that can include instructions to cause the processor 220 to perform one or more processes, functions, and/or the like. In some implementations, the memory 210 can be a portable memory (e.g., a flash drive, a portable hard disk, and/or the like) that can be operatively coupled to the processor 220. In some instances, the memory can be remotely operatively coupled with the compute device 201, for example, via the network interface 230. For example, a remote database server can be operatively coupled to the compute device 201.

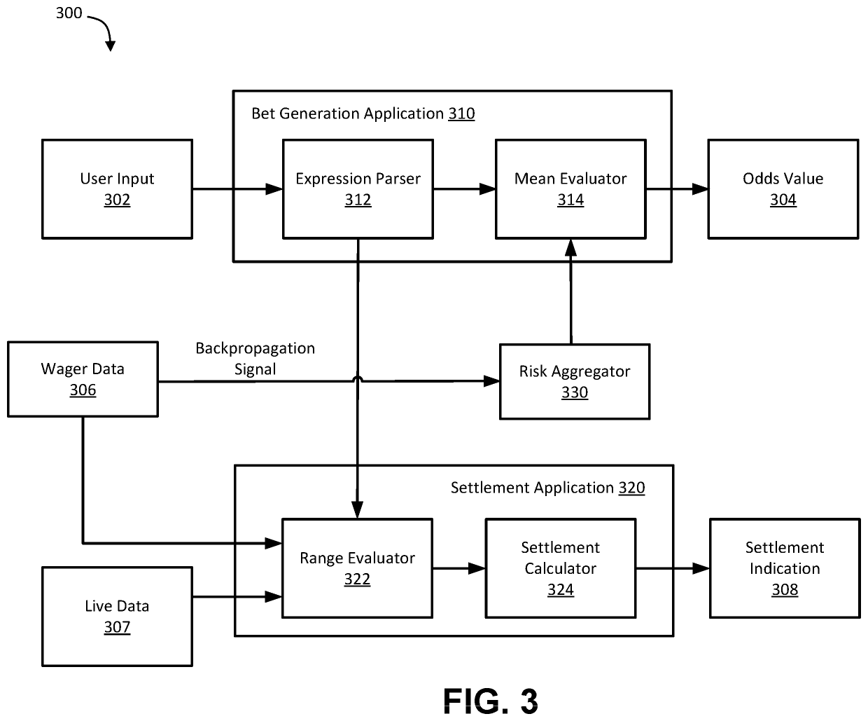

The memory 210 can store various instructions associated with programs, algorithms, and/or data (e.g., a bet generation application 212, a settlement application 214, a risk aggregator 216, at least a portion of the software components 300 of FIG. 3 (described herein), and/or the like). Memory 210 can further include any non-transitory computer-readable storage medium for storing data and/or software that is executable by processor 220, and/or any other medium which may be used to store information that may be accessed by processor 220 to control the operation of the compute device 201.

The network interface 230 can be configured to connect to the network N using any of the wired and wireless short range communication protocols described above, as well as a cellular data network, a satellite network, free space optical network and/or the Internet.

In some instances, the compute device 201 can further include a display, an input device, and/or an output device (not shown in FIG. 2). The display can be any display device by which the compute device 201 can output and/or display data such as a computer monitor (e.g., with LCD having LED backlight). The input device can include a mouse, keyboard, touch screen, voice interface, and/or any other hand-held controller, device or interface via which a user may interact with the compute device 201. The output device can include a bus, port, and/or other interfaces by which the compute device 201 may connect to and/or output data to other devices and/or peripherals.

FIG. 3 is a schematic diagram illustrating software components 300. The software components 300 can be associated with at least one compute device (e.g., at least one compute device that is structurally and/or functionally similar to the compute device 201 of FIG. 2 and/or the bet facilitation compute device 110 of FIG. 1). In some instances, for example, the software components 300 can be implemented as software stored in memory 210 and configured to be executed via the processor 220 of FIG. 2. In some instances, for example, at least a portion of the software components 300 can be implemented in hardware. The software components 300 includes a bet generation application 310 (which can be structurally and/or functionally equivalent to the bet generation application 212 of FIG. 2), a settlement application 320 (which can be structurally and/or functionally equivalent to the settlement application 214 of FIG. 2), and a risk aggregator 330 (which can be structurally and/or functionally equivalent to the risk aggregator 216 of FIG. 2).

The bet generation application 310 can be configured to accept, as input, user input 302 to generate an odds value 304. The user input 302 can include, for example, at least one input provided by a customer (e.g., a betting operator) and/or a bettor. This at least one input can include, for example, an event identifier associated with an event (e.g., a sporting event/match), an indication of a type of bet (e.g., a ticket bet, money line bet, a proposition bet, etc.), and/or an expression that includes at least one variable associated with an occurrence and/or non-occurrence that has a chance of occurring within the event associated with the event identifier. The expression can be a Boolean or a non-Boolean expression. In some implementations, a customer can define the expression (e.g., via the customer compute device 120 of FIG. 1) using a domain-specific programming language. In some implementations, a customer and/or bettor can define the expression using a graphical user interface (e.g., via a display operably coupled to the customer compute device 120 of FIG. 1).

The bet generation application 310 includes the expression parser 312 and the mean evaluator 314. The expression parser 312 can generate a parse tree based on the expression included in the user input 302. The parse tree can include, for example, a node for each variable and mathematical symbol/operator included in the expression, and the parse tree can be configured for efficient parsing performed by, for example, the mean evaluator 314. The mean evaluator 314 can generate an odds value 304 (e.g., a ticket price and/or indication of a likelihood of a payout) based on the parse tree and using a model (e.g., a machine learning model and/or a statistical model). Having generated the odds value 304, the bet generation application 310 can be configured to send a signal to a user compute device (e.g., the customer compute device 120 and/or the bettor compute device 130 of FIG. 1, and/or a compute device associated with a customer (e.g., betting operator) and/or bettor), such that the odds value 304 can be displayed to a bettor, allowing the bettor to decide whether they would like to wager on the bet defined by the expression.

If the bettor chooses to place a wager (e.g., an amount of money determined by the bettor and/or a fixed price for a ticket bet), the bettor can do so via, for example, the GUI. After the wager is placed by the bettor, the user compute device (e.g., the customer compute device 120 of FIG. 1) can be configured to send wager data 306 that defines the wager (e.g., a wager amount, a ticket purchase price paid, an identifier associated with the bettor, an identifier associated with the bet, etc.), and the settlement application 320 can receive the wager data 306 to continuously, periodically, and/or incrementally check the status of the bet. For example, the settlement application 320 can receive live data 307 to monitor occurrences that transpire in a sporting event, and based on the live data 307, the settlement application 320 can determine whether to settle the wager indicated in the wager data 306. In some implementations, the live data 307 can be streamed to the settlement application 320, and the live data can include, for example, a tabulation of occurrences (e.g., goals, penalties, flags, throw-ins, etc.). In some implementations, the live data 307 can be generated from a television feed of the sporting event using machine vision techniques, from a live blog/social media update feed of the sporting event using natural language processing techniques, and/or from an audio feed of the sporting event using audio/signal processing techniques.

The settlement application 320 includes the range evaluator 322 and the settlement calculator 324. The range evaluator 322 can determine, based on the live data 307 (indicating whether an occurrence within the match has transpired), a range of possible values for each variable (e.g., number of throw-ins by the home team) included in the expression. Based on these variable ranges, the settlement calculator 324 can determine a range of possible values for the overall expression. If, based on this outcome range, the settlement application 320 determines that the expression will evaluate to a determined value (e.g., true, false, etc.) regardless of any further occurrences that transpire within the event that is still in progress, the settlement application 320 can generate a settlement indication 308. The settlement indication 308 can include, for example, an indication of an amount to be paid to the bettor (the amount determined based on the odds value 304 and/or the wager amount indicated in the wager data 306) and/or an indication of whether a bet has been won and/or lost. The settlement indication 308 can be sent to the user compute device before the event ends, such that a payout can be issued to the bettor if the settlement application 320 determines that the bettor has won their bet, even though the event is still in progress. An event ends when, for example, a final score for the event (e.g., game/match) is determined. A final score can be determined when, for example, time for the match expires, a referee blows a final whistle that signals an end to the match, a team scores in sudden-death overtime, the last inning and/or over of the event has been played, etc. In some instances, an event can included multiple segments, and the event can end upon completion of the final segment. For example, a single event can include a cricket match played over multiple days. A single event can also include, for example, a baseball game played over multiple days due to a weather delay and/or a hockey game that includes one or more overtime periods.

The wager data 306 can be further provided as a backpropagation signal to the risk aggregator 330, which can determine, for example, (1) an imbalance between wagers placed on one outcome of a bet versus an opposite outcome of the bet and/or (2) a large number of wagers/high value wagers being placed on a bet. In some implementations, the risk aggregator 330 can add the wager data 306 to an accumulated dataset of wager data associated with previous similar bets (e.g., previous bets involving a same team and/or a same variable as the bet associated with the wager data 306). Similarly stated, the wager data 306 can be assigned, via the backpropagation signal, to at least one parameter associated with at least one variable included in the expression for which the wager data 306 was placed. The at least one parameter can be included in a parameter space associated with a machine learning model and/or statistical model. For example, the at least one parameter can represent a neural network weight and/or the like. Wager data for expressions including the at least one variable can also be aggregated, via respective backpropagation signals, at the at least one parameter.

The assignment of the aggregated wager data can cause a modification to a parameter, which can cause a modification to a machine learning model and/or statistical model including the parameter. As a result of the modification(s), the mean evaluator 314 can include a modified model that can generate revised odds values to, for example, dissuade further wagers on a lopsided bet and/or persuade bettors to bet on an opposite outcome. In some implementations, the modified model can be used to generate revised odds for a plurality of bets, including bets associated with different variables (e.g., bets associated with a different combination of occurrences), teams, events, etc., than those associated with the bet for which the original (e.g., pre-modification) odds value 304 was generated. To modify the parameter, the risk aggregator 330 can determine a slope/derivative of an error between, for example, a predicted odds value and a target (e.g., desired) odds value. The risk aggregator 330 can then adjust the parameter in proportion to the negative of the derivative, such that the resulting modified machine learning model achieves a reduced-error configuration. In some implementations, the risk aggregator 330 can modify one or more parameters incrementally, periodically, continuously, iteratively, and/or the like. For example, the wager data 306 can be streamed to the risk aggregator 330, such that the machine learning model and/or statistical model can be modified contemporaneously to changing betting behavior observed in an aggregate of bettors.

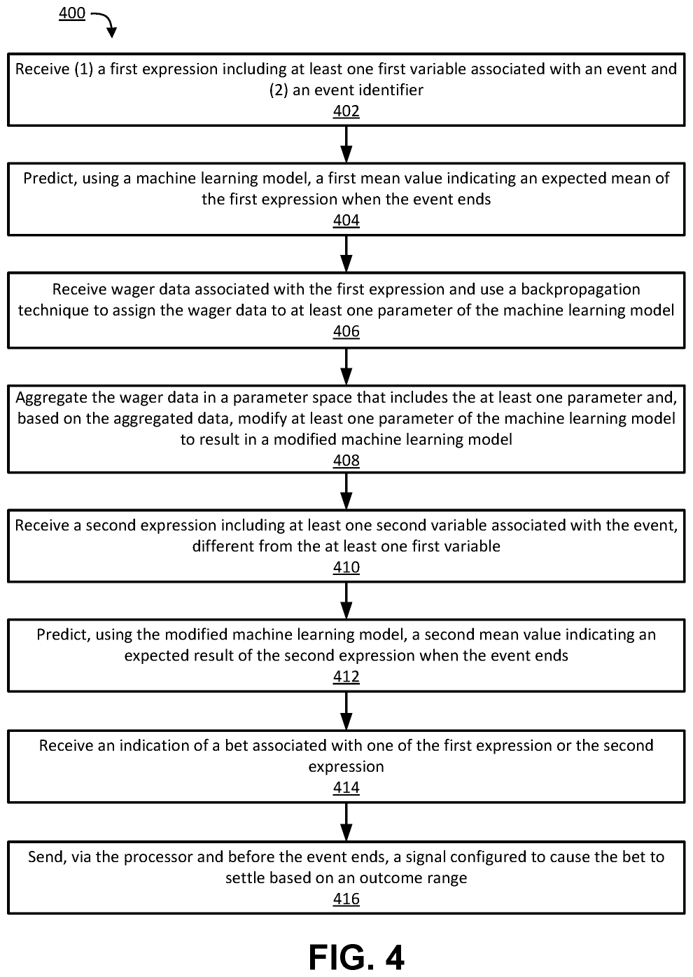

FIG. 4 is a flowchart showing a method 400 of generating odds and causing bets to settle. At 402, the method 400 includes receiving, at a processor, (1) a first expression including at least one first variable associated with an event and not deterministic of a final score for the event, and (2) an event identifier associated with the event. The first expression and/or the event identifier can be received from, for example, a user compute device. In some implementations, the first expression can be generated based at least one condition received at a user interface. The method 400 at 404 includes predicting, via the processor, based on the first expression and the event identifier, and using a machine learning model trained on historical data associated with the event, a first mean value indicating an expected mean of the first expression when the event ends. At 406, the method 400 includes receiving, at the processor, wager data associated with the first expression, and using a backpropagation technique to assign the wager data to at least one parameter of the machine learning model. The method 400 at 408 includes aggregating, via the processor, the wager data in a parameter space that includes the at least one parameter and, based on the aggregated data, modifying, via the processor, at least one parameter of the machine learning model to result in a modified machine learning model.

The method 400 at 410 includes receiving, at the processor, a second expression including at least one second variable associated with the event, different from the at least one first variable, and not determinative of the final score for the event. At 412, the method 400 includes predicting, via the processor and using the modified machine learning model, a second mean value indicating an expected result of the second expression when the event ends. The method 400 at 414 includes receiving, at the processor, an indication of a bet associated with one of the first expression or the second expression. At 416, the method 400 includes sending, via the processor and before the event ends, a signal configured to cause the bet to settle based on an outcome range. To generate the outcome range, a variable range is generated for each variable from one of the at least one first variable or the at least one second variable. A variable range is generated based on live data associated with the event. Then, an outcome range is generated based on (1) one of the first expression or the second expression and (2) the variable range for each variable from one of the at least one first variable or the at least one second variable.

In some instances, the method 400 can be implemented, for example, using a bet facilitation system described herein (e.g., the bet facilitation system 100 of FIG. 1). Portions of the method 400 can be implemented using a processor (e.g., the processor 220 of FIG. 2) of any suitable compute device (e.g., the bet facilitation compute device 110 of FIG. 1 and/or the compute device 201 of FIG. 2).

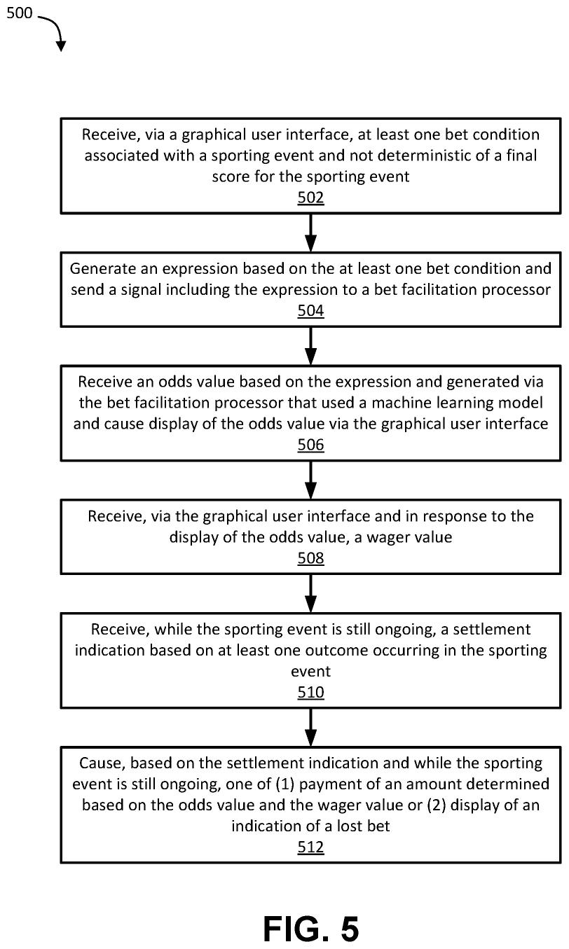

FIG. 5 is a flowchart showing a method 500 of receiving bet definition information, displaying odds information, and causing bets to settle, according to an embodiment. At 502, the method 500 includes receiving, via a graphical user interface, at least one bet condition associated with a sporting event and not deterministic of a final score for the sporting event. The at least one condition can be associated with, for example, an occurrence and/or a non-occurrence (e.g., a corner kick or a threshold number of corner kicks) that can transpire during the sporting event to trigger a payout. Said differently, the at least one condition can be associated with an occurrence and/or non-occurrence on which a bet is predicated. The method 500 at 504 includes generating an expression based on the at least one bet condition and sending a signal including the expression to a bet facilitation processor. At 506, the method 500 includes receiving an odds value based on the expression and generated via the bet facilitation processor that used a machine learning model. In response to the odds value being displayed via the graphical user interface, the method 500 at 508 includes receiving a wager value via the graphical user interface. At 510, the method 500 includes receiving, while the sporting event is still ongoing, a settlement indication based on at least one outcome occurring in the sporting event. The method 500 at 512 includes causing, based on the settlement indication and while the sporting event is still ongoing, one of (1) payment of an amount determined based on the odds value and the wager value or (2) display of an indication of a lost bet.

The method 500 can be implemented, for example, using a bet facilitation system described herein (e.g., the bet facilitation system 100 of FIG. 1). Portions of the method 500 can be implemented using a processor of any suitable compute device (e.g., the customer compute device 120 and/or the bettor compute device 130 of FIG. 1). The method 500 can include a method of receiving bet definition information, displaying odds information, and causing bets to settle, according to an embodiment.

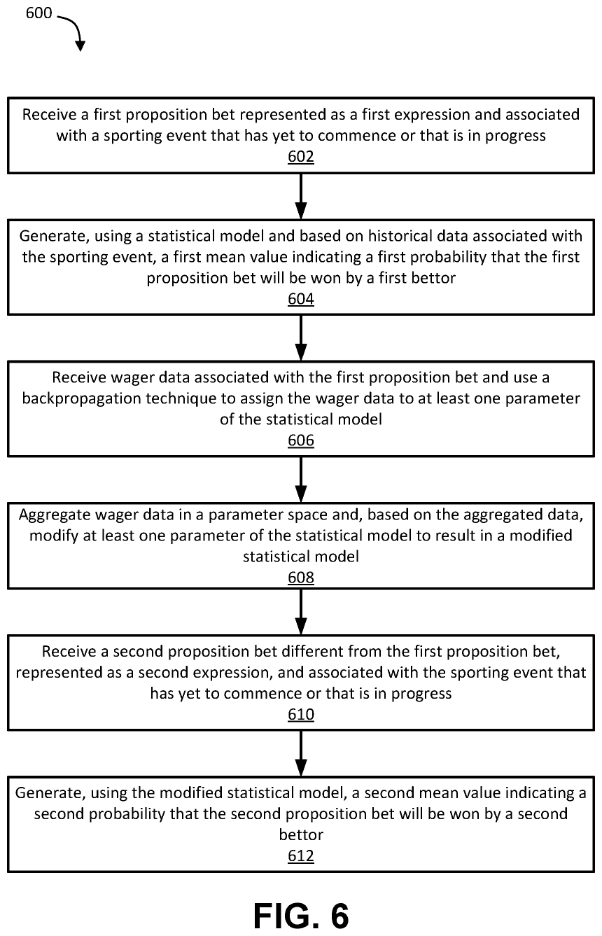

FIG. 6 is a flowchart showing a method 600 of modifying a machine learning model based on aggregated wager data, according to an embodiment. At 602, the method 600 includes receiving a first proposition bet represented as a first expression and associated with a sporting event that has yet to commence or that is in progress. The method 600 at 604 includes generating, using a statistical model and based on historical data associated with the sporting event, a first mean value indicating a first probability that the first proposition bet will be won by a first bettor. At 606, the method 600 includes receiving, at the processor, wager data associated with the first proposition bet, and using a backpropagation technique to assign the wager data to at least one parameter of the statistical model. The method 600 at 608 includes aggregating, via the processor, the wager data in a parameter space that includes the at least one parameter and, based on the aggregated data, modifying, via the processor, at least one parameter of the statistical model to result in a modified statistical model. The method 600 at 610 includes receiving a second proposition bet different from the first proposition bet, represented as a second expression, and associated with the sporting event that has yet to commence or that is in progress. At 612, the method 600 includes generating, using the modified statistical model, a second mean value indicating a second probability that the second proposition bet will be won by a second bettor.

The method 600 can be implemented using a bet facilitation system described herein (e.g., the bet facilitation system 100 of FIG. 1). Portions of the method 600 can be implemented using a processor of any suitable compute device (e.g., the bet facilitation compute device 110 of FIG. 1 and/or the compute device 201 of FIG. 2).

In an embodiment, a method includes receiving, at a processor, (1) a first expression including at least one first variable associated with an event and not deterministic of a final score for the event, and (2) an event identifier associated with the event. The method also includes predicting, via the processor, based on the first expression and the event identifier, and using a machine learning model trained on historical data associated with the event, a first mean value indicating an expected mean of the first expression when the event ends. The method also includes receiving, at the processor, wager data associated with the first expression, and sending, via the processor and based on the wager data, a backpropagation signal to cause a modification to one or more parameters included in the machine learning model to produce a modified machine learning model. The method also includes receiving, at the processor, a second expression including at least one second variable associated with the event, different from the at least one first variable, and not determinative of the final score for the event. The method also includes predicting, via the processor and using the modified machine learning model, a second mean value indicating an expected result of the second expression when the event ends. Additionally, the method includes receiving, at the processor, an indication of a bet associated with one of the first expression or the second expression. The method also includes generating, via the processor and based on live data associated with the event, a variable range for each variable from one of the at least one first variable or the at least one second variable. The method also includes generating, via the processor, an outcome range based on (1) one of the first expression or the second expression and (2) the variable range for each variable from one of the at least one first variable or the at least one second variable. The method also includes sending, via the processor and before the event ends, a signal configured to cause the bet to settle based on the outcome range.

In some implementations, the event can be a sporting event, and the event identifier can indicate at least one of entities involved in the sporting event or a date on which the sporting event is held. In some implementations, the first expression and the second expression are each represented using a domain-specific programming language. In some implementations, the first expression can include a first Boolean expression and the second expression can include a second Boolean expression, the first mean value can represent a first probability that the first Boolean expression will evaluate to 1 when the event ends, and the second mean value represents a second probability that the second Boolean expression will evaluate to 1 when the event ends. In some implementations, the bet can include a proposition bet. In some implementations, at least one of the first expression or the second expression can include at least two variables associated with the event and not determinative of the final score of the event. In some implementations, the event can be a first event, and the historical data can include outcome data for at least one second event associated with the first event. In some implementations, the method can further include generating, via the processor and using the machine learning model, a confidence value associated with the first mean value. In some implementations, the predicting can include (1) generating, via the processor, a parse tree based on the first expression, the parse tree having at least one node associated with the at least one first variable, and (2) generating, via the processor and using the machine learning model, the first mean value based on the parse tree. In some implementations, the signal can be a first signal, and the method can further include receiving, at the processor, a payout rate indicating a desired payout to received wager ratio, generating, via the processor, an odds value indicating a likelihood of payout based on one of the first mean value or the second mean value, and the payout rate, and sending, via the processor, a second signal configured to cause the one of the first mean value or the second mean value to be displayed at a user compute device.

In an embodiment, a non-transitory processor-readable medium can store code representing instructions to be executed by one or more processors, the instructions including code to cause the one or more processors to receive, via a graphical user interface, at least one bet condition associated with a sporting event and not deterministic of a final score for the sporting event. The code also causes the one or more processors to generate an expression based on the at least one bet condition, send a signal including the expression to a bet facilitation processor, and receive an odds value based on the expression and generated via the bet facilitation processor that used a machine learning model. The code also causes the one or more processors to cause display of the odds value via the graphical user interface, receive, via the graphical user interface and in response to the display of the odds value, a wager value, and receive, while the sporting event is still ongoing, a settlement indication based on at least one outcome occurring in the sporting event. The code also causes the one or more processors to cause, based on the settlement indication and while the sporting event is still ongoing, one of (1) payment of an amount determined based on the odds value and the wager value or (2) display of an indication of a lost bet.

In some implementations, the at least one bet condition can be associated with a proposition bet. In some implementations, the at least one bet condition can be associated with a ticket bet. In some implementations, the signal can be a first signal, and the code can further include code to cause the one or more processors to send a second signal including the wager value to the bet facilitation processor, receive a revised odds value based on the wager value and generated via the bet facilitation processor that used the machine learning model, and cause display of the revised odds value via the graphical user interface. In some implementations, the at least one bet condition can be at least one first bet condition, the expression can be a first expression, the odds value can be a first odds value, and the code can further include code to cause the one or more processors to receive, via the graphical user interface, at least one second bet condition associated with the sporting event and not deterministic of a final score for the sporting event, generate a second expression based on the at least one second bet condition, send a third signal including the second expression to the bet facilitation processor, receive a second odds value based on the second expression and the wager value and generated via the bet facilitation processor that used the machine learning model, and cause display of the second odds value via the graphical user interface.

In an embodiment, a non-transitory processor-readable medium can store code representing instructions to be executed by one or more processors, the instructions including code to cause the one or more processors to receive a first proposition bet represented as a first expression and associated with a sporting event that has yet to commence or that is in progress. The code also causes the one or more processors to generate, using a statistical model and based on historical data associated with the sporting event, a first mean value indicating a first probability that the first proposition bet will be won by a first bettor. The code also causes the one or more processors to receive aggregated wager data associated with the first proposition bet and modify, based on the aggregated wager data and using a backpropagation technique, at least one parameter included in the statistical model to result in a modified statistical model. The code also causes the one or more processors to receive a second proposition bet different from the first proposition bet, represented as a second expression, and associated with the sporting event that has yet to commence or that is in progress. The code also causes the one or more processors to generate, using the modified statistical model, a second mean value indicating a second probability that the second proposition bet will be won by a second bettor.

In some implementations, the code can further include code to cause the one or more processors to generate a parse tree based on the first proposition bet, the parse tree configured to be used as input by the statistical model to generate the first mean value. In some implementations, the code can further include code to cause the one or more processors to receive event data associated with (1) the sporting event and (2) at least one variable included in at least one of the first expression or the second expression and generate a future outcome range for each variable from the at least one variable based on the event data. This code can further cause the one or more processors to generate a settlement indication based on the future outcome range for each variable from the at least one variable, the settlement indication indicating that at least one of the first expression or the second expression is determined and cause transmission of the settlement indication to facilitate a settlement associated with at least one of the first proposition bet or the second proposition bet. In some implementations, the settlement indication can be generated while the sporting event is still in progress. In some implementations, a variable from the at least one variable can be not deterministic of a final outcome for the sporting event.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. A method, comprising:
receiving, at a processor, (1) a first expression including at least one first variable associated with an event and not deterministic of a final score for the event, and (2) an event identifier associated with the event;
predicting, via the processor, based on the first expression and the event identifier, and using a machine learning model trained on historical data associated with the event, a first mean value indicating an expected mean of the first expression when the event ends;
receiving, at the processor, wager data associated with the first expression;
sending, via the processor and based on the wager data, a backpropagation signal to cause a modification to one or more parameters included in the machine learning model to produce a modified machine learning model;
receiving, at the processor, a second expression including at least one second variable associated with the event, different from the at least one first variable, and not determinative of the final score for the event;
predicting, via the processor and using the modified machine learning model, a second mean value indicating an expected result of the second expression when the event ends;
receiving, at the processor, an indication of a bet associated with one of the first expression or the second expression;
generating, via the processor and based on live data associated with the event, a variable range for each variable from one of the at least one first variable or the at least one second variable;
generating, via the processor, an outcome range based on (1) one of the first expression or the second expression and (2) the variable range for each variable from one of the at least one first variable or the at least one second variable; and
sending, via the processor and before the event ends, a signal configured to cause the bet to settle based on the outcome range.

2. The method of claim 1, wherein:
the event is a sporting event; and
the event identifier indicates at least one of entities involved in the sporting event or a date on which the sporting event is held.

3. The method of claim 1, wherein the first expression and the second expression are each represented using a domain-specific programming language.

4. The method of claim 1, wherein:
the first expression includes a first Boolean expression and the second expression includes a second Boolean expression;
the first mean value represents a first probability that the first Boolean expression will evaluate to 1 when the event ends; and
the second mean value represents a second probability that the second Boolean expression will evaluate to 1 when the event ends.

5. The method of claim 1, wherein the bet includes a proposition bet.

6. The method of claim 1, wherein at least one of the first expression or the second expression includes at least two variables associated with the event and not determinative of the final score of the event.

7. The method of claim 1, wherein the event is a first event, and the historical data includes outcome data for at least one second event associated with the first event.

8. The method of claim 1, wherein the method further includes generating, via the processor and using the machine learning model, a confidence value associated with the first mean value.

9. The method of claim 1, wherein the predicting includes:
generating, via the processor, a parse tree based on the first expression, the parse tree having at least one node associated with the at least one first variable; and
generating, via the processor and using the machine learning model, the first mean value based on the parse tree.

10. The method of claim 1, wherein the signal is a first signal, and the method further comprises:
receiving, at the processor, a payout rate indicating a desired payout to received wager ratio;
generating, via the processor, an odds value indicating a likelihood of payout based on one of the first mean value or the second mean value, and the payout rate; and
sending, via the processor, a second signal configured to cause the one of the first mean value or the second mean value to be displayed at a user compute device.

11. A non-transitory processor-readable medium storing code representing instructions to be executed by one or more processors, the instructions comprising code to cause the one or more processors to:
receive, via a graphical user interface, at least one bet condition associated with a sporting event and not deterministic of a final score for the sporting event;
generate an expression based on the at least one bet condition;
send a signal including the expression to a bet facilitation processor;
receive an odds value based on the expression and generated via the bet facilitation processor that used a machine learning model;
cause display of the odds value via the graphical user interface;
receive, via the graphical user interface and in response to the display of the odds value, a wager value;
receive, while the sporting event is still ongoing, a settlement indication based on at least one outcome occurring in the sporting event; and
cause, based on the settlement indication and while the sporting event is still ongoing, one of (1) payment of an amount determined based on the odds value and the wager value or (2) display of an indication of a lost bet.

12. The non-transitory processor-readable medium of claim 11, wherein the at least one bet condition is associated with a proposition bet.

13. The non-transitory processor-readable medium of claim 11, wherein the at least one bet condition is associated with a ticket bet.

14. The non-transitory processor-readable medium of claim 11, wherein the signal is a first signal, and the code further comprises code to cause the one or more processors to:
send a second signal including the wager value to the bet facilitation processor;
receive a revised odds value based on the wager value and generated via the bet facilitation processor that used the machine learning model; and
cause display of the revised odds value via the graphical user interface.

15. The non-transitory processor-readable medium of claim 14, wherein the at least one bet condition is at least one first bet condition, the expression is a first expression, the odds value is a first odds value, and the code further comprises code to cause the one or more processors to:
receive, via the graphical user interface, at least one second bet condition associated with the sporting event and not deterministic of a final score for the sporting event;
generate a second expression based on the at least one second bet condition;
send a third signal including the second expression to the bet facilitation processor;
receive a second odds value based on the second expression and the wager value and generated via the bet facilitation processor that used the machine learning model; and
cause display of the second odds value via the graphical user interface.

16. A non-transitory processor-readable medium storing code representing instructions to be executed by one or more processors, the instructions comprising code to cause the one or more processors to:
receive a first proposition bet represented as a first expression and associated with a sporting event that has yet to commence or that is in progress;
generate, using a statistical model and based on historical data associated with the sporting event, a first mean value indicating a first probability that the first proposition bet will be won by a first bettor;
receive aggregated wager data associated with the first proposition bet;
modify, based on the aggregated wager data and using a backpropagation technique, at least one parameter included in the statistical model to result in a modified statistical model;
receive a second proposition bet different from the first proposition bet, represented as a second expression, and associated with the sporting event that has yet to commence or that is in progress; and
generate, using the modified statistical model, a second mean value indicating a second probability that the second proposition bet will be won by a second bettor.

17. The non-transitory processor-readable medium of claim 16, wherein the code further comprises code to cause the one or more processors to:
generate a parse tree based on the first proposition bet, the parse tree configured to be used as input by the statistical model to generate the first mean value.

18. The non-transitory processor-readable medium of claim 16, wherein the code further comprises code to cause the one or more processors to:
receive event data associated with (1) the sporting event and (2) at least one variable included in at least one of the first expression or the second expression;
generate a future outcome range for each variable from the at least one variable based on the event data;
generate a settlement indication based on the future outcome range for each variable from the at least one variable, the settlement indication indicating that at least one of the first expression or the second expression is determined; and
cause transmission of the settlement indication to facilitate a settlement associated with at least one of the first proposition bet or the second proposition bet.

19. The non-transitory processor-readable medium of claim 18, wherein the settlement indication is generated while the sporting event is still in progress.

20. The non-transitory processor-readable medium of claim 18, wherein a variable from the at least one variable is not deterministic of a final outcome for the sporting event.
